(19) United States
(12) Patent Application Publication
(10) Pub. No.: US 2014/0053262 A1
(43) Pub. Date: Feb. 20, 2014

(54) Secure Display for Secure Transactions

(71) Applicants: Nitin V. Sarangdhar, Portland, OR (US); Satyanarayana Avadhanam, El Dorado Hills, CA (US); Srikanth Kambhatla, Portland, OR (US)

(72) Inventors: Nitin V. Sarangdhar, Portland, OR (US); Satyanarayana Avadhanam, El Dorado Hills, CA (US); Srikanth Kambhatla, Portland, OR (US)

(21) Appl. No.: 13/994,839

(22) PCT Filed: Sep. 30, 2011
(86) PCT No.: PCT/US11/54468

§ 371 Date: Nov. 4, 2013

(51) Int. Cl. H04L 29/06

(52) U.S. Cl. CPC H04L 63/145
USPC 726/22

(57) ABSTRACT

A platform may use a central processing unit to run an operating system. Independently of the operating system, in the central processing unit, a hardware controller, such as a manageability engine, may be used to control which window is on the top of the Z-order and thereby control which window is displayed to the user. As a result, in some embodiments, the hardware controller can prevent an interloper or malware from interjecting an illegitimate window over a legitimate window that the user actually desired to access. In addition, a hardware indicator may be provided to assure the user when an accessed website is legitimate.

### BACKGROUND

This relates generally to computer systems and, particularly, to counteracting malware attacks.

Malware is software that the owner or user of a computer system did not install. It typically enters the computer system without the knowledge of the user. The intent of the malware is to damage the user's system or to obtain monetary benefit. Although malware may run anywhere in the system, the most prevalent malware in computers today runs inside the host operating system and is a program that executes on the central processing unit.

One type of attack occurs when the user thinks the user has accessed a legitimate website and, in fact, he may have. For example, a user wishing to do online banking may contact the website of the user's bank. However, malware using screen scraping may scrape the contents of a frame buffer and use that scraped content to create an imitation of the bank's website on the user's display. The malware can do that by manipulating the Z-order buffer to change the order of display, putting its imitation on the top of the screen display. In such case, the legitimate website is still in Z-order under the illegitimate image displayed on the computer screen, but since it underlies the screen display displayed by the malware, the legitimate image is not visible. Thus, the user thinks that the user is entering information in a trusted website when, in fact, the user may be providing information that the malware can use, for example, to steal money.

Another type of attack, called phishing, occurs when the user receives an email inviting the user to access a webpage. For example, a user may receive an email purportedly from the user's bank, but, in fact, the email was sent by an illegitimate source. When the user attempts to access a referenced website, a fake website may appear. The fake website may have been generated using screen scraping or other techniques. Again, the user may enter information, thinking that the user has accessed a legitimate, authorized website, but, in fact, is only accessing a website put up by thieves to imitate the website of the user's bank.

### BRIEF DESCRIPTION OF THE DRAWINGS

FIG. 1 is an architectural level depiction of one embodiment of the present invention;

FIG. 2 is a flow chart for a registration sequence in accordance with one embodiment;

FIG. 3 is a flow chart for a secure website access sequence in accordance with one embodiment of the present invention; and

FIG. 4 is a flow chart for a sequence for controlling the Z-order buffer, according to one embodiment.

### DETAILED DESCRIPTION

In accordance with some embodiments of the present invention, secure hardware on a computer platform may ensure that the Z-order or order of overlaid display frames on a display screen is controlled in a way that only authentic websites are displayed at the top level.

Just as pieces of paper on a real desktop can overlap one another, windows on a computer display are drawn in a Z-order that specifies which windows are drawn on the top of other windows. The window with the highest Z-order is the topmost displayed window, and may obscure portions or the entirety of one or more underlying windows having a lower Z-order.

By controlling, in a secure fashion, what window is displayed on the top of the Z-order buffer, malware is unable to screen scrape a website accessed by the user and overlay a malware controlled window over the legitimate window of an accessed website.

In some embodiments, a hardware based indicator, such as an indicator light, may be provided when an accessed website is authenticated and determined to be legitimate. Since the indicator is hardware based, malware cannot interfere with the indicator and, therefore, the indicator may provide a reliable means of identifying situations where the platform is displaying an illegitimate website.

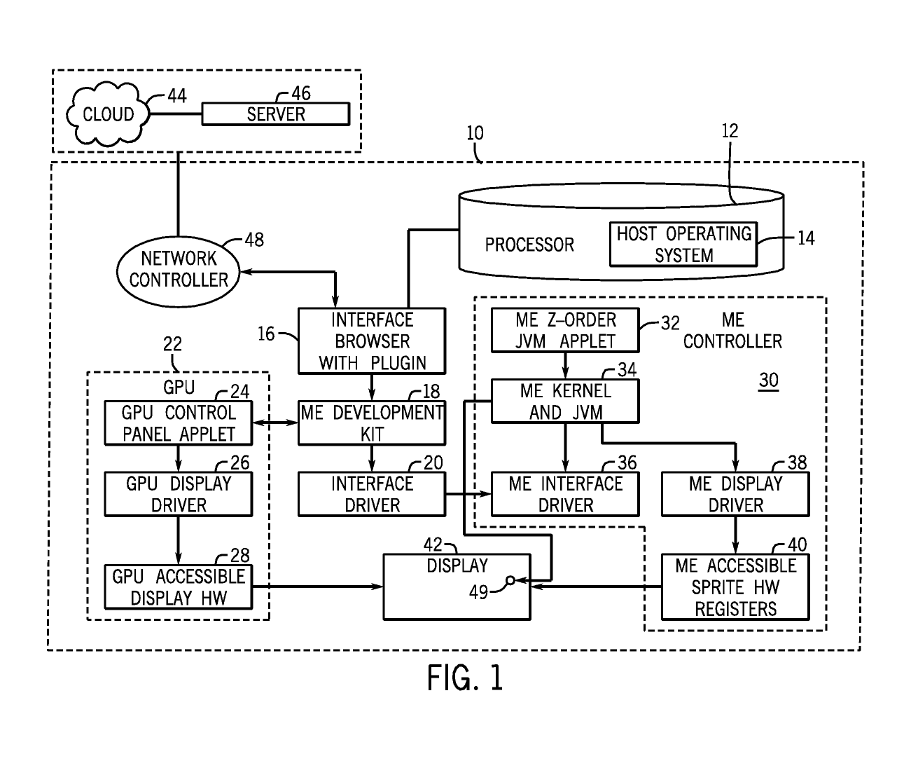

Referring to FIG. 1, a platform 10 may be any type of computer system, but, advantageously, may be a computer system with a built-in display screen, such as a tablet, a laptop, mobile Internet device (MID) or a cell phone. However, the present invention is not limited to platforms with built-in display screens.

The platform 10 may include one or more central processing units 12 which run operating system 14. The term “host” may be used to refer to any software, firmware, or hardware resident on the platform and run by the processor 12 or the operating system 14. Other host components include a network controller 48, an Internet browser with a plug-in 16, a manageability engine development kit 18, and an interface driver 20. The Internet browser 16 may include a plug-in which enables various features described hereinafter to be implemented.

The plug-in modifies conventional Internet browser capabilities to facilitate the implementation of some embodiments of the present invention. Of course, instead of using a plug-in, the Internet browser could be completely rewritten to accommodate those same features, in some embodiments.

The manageability engine development kit 18 provides an interface between the Internet browser and an interface driver 20. The interface driver 20 provides information to a manageability engine controller 30.

A graphics processing unit (GPU) 22 may include components that execute sequences controlled by the central processing unit 12. For example, a graphics control panel applet 24 may create a user interface to enable a user to select various configurations for display, such as video mode, resolution, refresh rate, and display configuration. Effectively, the control panel applet 24 allows the user to provide settings to control the operation of the graphics processing unit.

A graphics processing unit display driver 26 drives a graphics processing unit accessible display hardware 28. The hardware 28 runs a display 42. Thus, the components 24, 26, and 28 may be conventional, in some embodiments of the present invention, and may drive the display 42 in a conventional way in cases where features of embodiments of the present invention are not selected or available.

In some embodiments, the platform may include a single chipset that includes all the components of the platform 10, depicted in FIG. 1. That chipset may include a security coprocessor, such as manageability engine controller 30. The manageability engine controller 30 is a controller or processor that runs independently and in secure isolation from the software running on the processor 12 and, particularly, the host operating system 14. As a result, the manageability engine controller 30 components are not attacked by malware running as an application on the host operating system 14. This provides a high level of security, in some embodiments. The manageability engine may, for example, be part of Intel's Active Management Technologies (AMT), however, any other security coprocessor may also be used.

The manageability engine controller 30 controls what is put on the top of the Z-order. As a result, it can prevent interlopers or malware from overlaying an illegitimate window over a legitimate display window in order to fool a user into providing confidential information.

The manageability engine controller may include a manageability engine Z-order Java virtual machine applet 32. Although, in one embodiment, a Java virtual machine applet is used, other software may be used as well to control the Z-order through any independent controller, including, but not limited to, the Intel Manageability Engine technology.

A manageability engine kernel and Java virtual machine 34 may be used, but, again, the present invention is not limited to the Intel manageability engine or to implementations using Java virtual machines. The kernel 34 provides commands to a manageability interface driver 36 and a manageability display driver 38. Sprite hardware registers may provide data for display on the display 42.

The components 34, 36, 38, and 40, as well as the Z-order component 32, all run on the manageability engine controller independently from the host operating system 14 and, therefore, they are relatively immune from attack by malware. The manageability engine display driver 38 drives manageability engine accessible sprite hardware registers that are used by the Z-order applet to control what window is displayed on the top of the user's display. Basically, it controls the Z-order buffer so that the top of the Z-order is always a window selected and controlled by the manageability engine controller 30. The Z-order applet may provide commands to drive the manageability engine display driver and may control all communications between the manageability engine and external components. It may also control the manageability engine Z-order controls, as well as the hardware indicator 49, that indicates whether a website accessed by the user is a legitimate, authorized, and authenticated website.

Specifically, when the user accesses a website, a certificate exchange may occur to determine whether the manageability engine controller 30 recognizes the website as one that has a certificate that it recognizes as being legitimate. In such case, the manageability engine controller 30 and, particularly, the kernel 34, may operate the indicator 49 on the user's display 42. The indicator may actually be a hardware device, such as one or more light emitting diodes, to indicate that the accessed webpage is authentic. If the accessed webpage is authentic and the manageability engine controls what is on the top of the Z-order for display, it becomes very difficult for malware or interlopers to deceive the user.

Thus, in some embodiments, the indicator 49 may be integrated with the rest of the case of the platform 10 to facilitate a hardware based indication that the display being viewed is derived from a reliable source. The light emitting diode (LED) may, for example, flash one color to indicate the accessed website is authentic and verified and another color to indicate when the website is not authentic. Other visual indicators can be provided as well, including a small display screen that provides text indication of the acceptability of the accessed webpage. As another example, audio indications may be provided as well. In one embodiment, the LED may be integrated into the frame of the display 42. However, other embodiments are contemplated where an LED can be driven independently of host software dependence.

If the manageability engine is unable to authenticate the accessed webpage, the display proceeds in the conventional fashion using a graphics processing unit 22. The Z-order is not controlled and the indicator 49 would generally indicate that the authenticity of the accessed webpage cannot be verified.

Also shown in FIG. 1 is a cloud 44. The cloud may be a remote storage computer accessible by a plurality of platforms 10. The access by the platform may be via the network controller 48, in one embodiment, using a network of any type or the Internet. The cloud 44 may connect to a web server 46 that hosts the website which the user wishes to access.

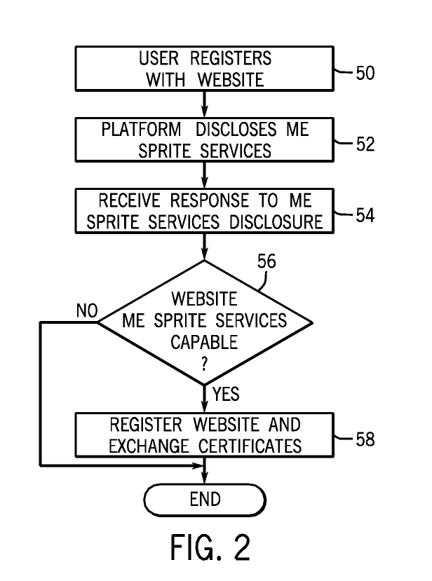

Referring to FIG. 2, a sequence for enabling website registration with the manageability engine controller 30 is depicted. The sequence of FIG. 2 may be implemented in software, firmware, and/or hardware. Generally, in software embodiments, it may be implemented by computer executable instructions stored on a non-transitory computer readable medium such as semiconductor, magnetic, or optical storage device.

Initially, the user accesses and registers with a desired website hosted, for example, by the server 46, as indicated in block 50. During the user registration process, the platform discloses the availability of the manageability engine's sprite services, as indicated in block 52. The platform 10 receives a response from the website, indicating whether or not the accessed website has the capability to use the manageability engine's sprite services, as indicated in block 54. If the website is manageability engine sprite services capable, as determined in block 56, the website is registered and security certificates are exchanged, as indicated in block 58.

In such case, the website's universal resource locator (URL) may be stored by the manageability engine controller 30 so, thereafter, the manageability engine's sprite services may be automatically activated as soon as website is contacted. This means that the manageability engine both controls the Z-order topmost display plane, as well as activates a hardware-based indicator 49, to provide the user the assurance that a window from an authenticated source is being displayed.

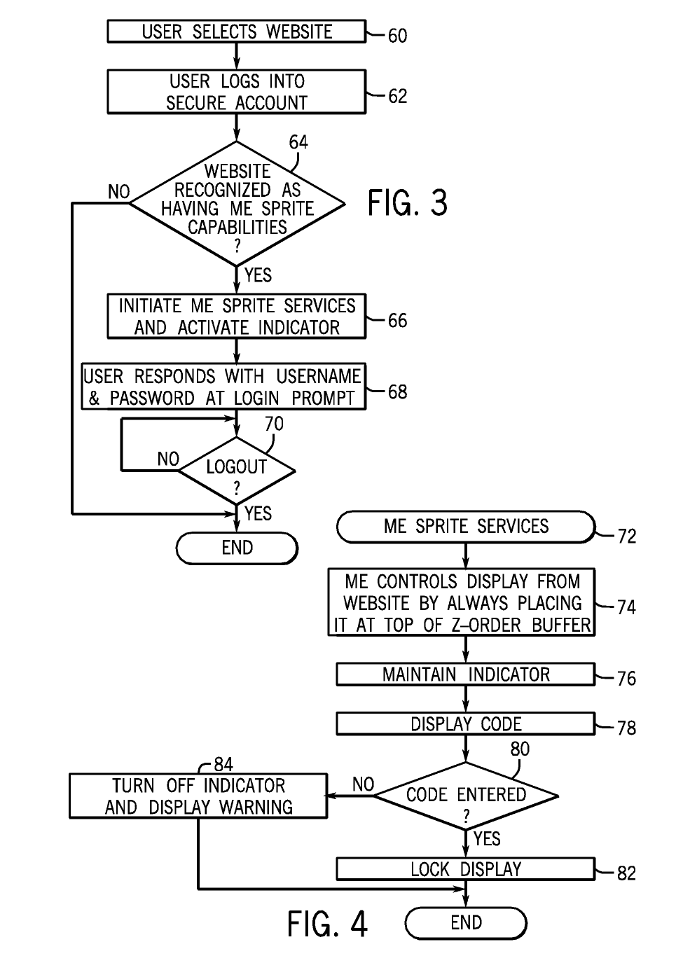

FIG. 3 depicts one embodiment of a sequence for accessing a website that has been previously registered. Again, the sequence may be implemented in software, hardware, and/or firmware. In software or firmware embodiments, it may be implemented by computer executable instructions stored on a non-transitory computer readable medium.

Initially, the user selects a website, as indicated in block 60, by entering its universal resource locator, for example, using the Internet browser with plug-in 16. The plug-in in the Internet browser is responsible, in some embodiments, for activating the sequence of FIG. 3. Then the user logs into his/her secure account on the website, as indicated in block 62. Logging into the secure account, in some embodiments, may automatically initiate a check at diamond 64 to determine whether the website is recognized as having the manageability engine's sprite capabilities. In the cases where it does, the manageability sprite services may be automatically initiated without any user action and the indicator 49 may be automatically activated, as indicated in block 66.

Otherwise, the manageability engine's sprite services are not used and the manageability engine controller 30 may not be used. In such case, the indicator will indicate that authenticity cannot be assured.

Then, in block 68, the user responds with the user name and password at the login prompt. The user then uses the website with some assurance of security, based on the ability of the manageability engine's sprite to control the Z-order and the indicator 49, indicating that the website is authentic. When the user is done, a logout occurs at 70.

Referring to FIG. 4, the manageability engine's sprite services 72 are basically implemented by the Z-order applet 32 and the kernel 34 in FIG. 1. The sequence may be implemented as hardware, software, and/or firmware. In software or firmware embodiments, the sequence may be implemented by computer executable instructions stored in a non-transitory computer readable medium executed by the manageability engine controller 30, in some embodiments.

The manageability engine controller controls the display from an accessed website, that has been recognized as having manageability engine sprite services, by also always placing that website's window at the top of the Z-order buffer, as indicated in block 74. In addition, as indicated in block 76, the indicator 49 is operated to indicate that the website is authentic.

In some embodiments, a visual display code may be displayed on the display 42 with text requesting that the user enter the display (block 78). In some embodiments, the display code may be generated by a random number generator so that it changes all of the time and is not as easily subverted by an interloper or malware. When the code is entered, as determined in diamond 80, the display may be locked in the secure mode (block 82). The entry of the correct code enables the manageability engine controller to confirm that it has effectively controlled the screen display on the display 42. If the code that the manageability engine generated is not provided as a user input, the indicator 49 may be turned off and a display warning may be issued, as indicated in block 84, to alert the user that an interloper or malware may have control of the user's display.

In some embodiments which include multiple displays, the display code may be used, even independently of the manageability engine controller 30 to allow host-based software to determine whether an interloper has interfered with its intended display, for example, by substituting the display.

In some embodiments, the platform developer and the website owner may exchange certificates by agreement, such that the platform may be assured of the authenticity of the website and the website may be assured of the authenticity of the platform. These certificates may be pre-provided to the respective entities. For example, the manufacturer of the computer platform or the manageability engine controller may provide the certificates to operators of websites known to be reliable and, for example, who agree to maintain certain levels of security.

In some embodiments, an indication of authenticity may be displayed on the display screen in addition to, or, even instead of, the hardware indicator 49. However, such a displayed indicator is subject to malware attacks.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
running an operating system on a central processing unit; and
using a hardware controller, independent of said unit, to control the Z-order display of windows.

2. The method of claim 1 including determining whether a website accessed by a platform is authentic and, if so, providing a hardware indication of authenticity.

3. The method of claim 1 including generating a display of a code and requesting the user to enter the code in an input/output device in order to determine whether a window is being displayed as expected.

4. The method of claim 1 wherein using a hardware controller includes using a manageability engine.

5. The method of claim 1 including controlling which window is on the top of the Z-order using hardware isolated from the operating system.

6. The method of claim 1 including providing a hardware indicator on a display screen to indicate that an accessed website has been authenticated.

7. The method of claim 1 including providing for the exchange of certificates between a platform accessing a website and a server for the website.

8. The method of claim 7 including enabling the platform to store an address of the website so that each time the website is accessed, the website may be automatically authenticated.

9. The method of claim 8 including enabling an on-screen random number display to associate the display to the user in a multi-display system.

10. A non-transitory computer readable medium storing instructions to enable a security coprocessor to:
control the Z-order display of windows.

11. The medium of claim 10 further storing instructions to determine whether a website accessed by a platform is authentic and, if so, providing an indication of authenticity.

12. The medium of claim 11 further storing instructions to generate a display of code and request the user to enter the code in an input/output device in order to determine whether a window is being displayed as expected.

13. The medium of claim 11 further storing instructions to provide an indicator on a display screen to indicate that an accessed website has been authenticated.

14. The medium of claim 11 further storing instructions to provide for the exchange of certificates between a platform accessing a website and a server for the website.

15. The medium of claim 14 further storing instructions to enable the platform to store an address of the website so that each time the website is accessed, the website may be automatically authenticated.

16. The medium of claim 15 further storing instructions to enable an on screen random number display to associate the display to the user in a multi-display system.

17. An apparatus comprising:
a central processing unit running an operating system;
a security coprocessor coupled to said central processing unit, said security coprocessor to control the Z-order display of windows independently of said central processing unit.

18. The apparatus of claim 17, said apparatus to determine whether website accessed by the apparatus is authentic and, if so, provide an indication of authenticity from said security coprocessor.

19. The apparatus of claim 17, said apparatus to generate a display of a code and a request a user to enter a code in an input/output device in order to determine whether a window is being displayed as expected.

20. The apparatus of claim 17 wherein said security coprocessor is a manageability engine.

21. The apparatus of claim 17, said apparatus to control which window is on top of the Z-order using said security coprocessor.

22. The apparatus of claim 17, said apparatus to provide an indicator on a display screen to indicate that an accessed website has been authenticated.

23. The apparatus of claim 17, said apparatus to provide for the exchange of certificates between the apparatus accessing a website and a server for the website.

24. The apparatus of claim 23, said apparatus to store an address of the website so that each time the website is accessed by the apparatus, the website may be automatically authenticated.

25. The apparatus of claim 24, said apparatus to enable an on screen random number display to associate the display to the user in a multi-display system.

26. A security coprocessor comprising:
a unit to control the Z-order display of windows; and
a driver to control an indicator associated with a platform to indicate that a website has been authenticated by the security coprocessor.

27. The security coprocessor of claim 26 to drive a light to indicate that a website has been authenticated.

28. The security coprocessor of claim 26 to maintain an authenticated website on top of said display.

29. The security coprocessor of claim 26 wherein said coprocessor is a manageability engine.

30. The security coprocessor of claim 26 to authenticate a website.
